(19) United States
(12) Patent Application Publication
(10) Pub. No.: US 2005/0004918 A1
(43) Pub. Date: Jan. 6, 2005

(54) Populating a database using inferred dependencies

(75) Inventor: James Leonard Platt, Austin, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/612,701

(22) Filed: Jul. 2, 2003

(51) Int. Cl. G06F 17/00

(52) U.S. Cl. 707/100

(57) ABSTRACT

Populating a database, including providing a database having a schema; inferring from the schema dependencies among a fact table and related dimension tables; and inserting, in accordance with the dependencies, rows of data into the fact table and rows of data into the dimension tables. In typical embodiments, inferring dependencies further comprises selecting from metadata describing a schema for the database expressions of dependencies and inserting the expressions of dependencies into a dependency list. In typical embodiments, wherein inserting rows of data further comprises determining whether related dimension data exists for each foreign key in each row of data inserted into the fact table and for each foreign key for which related dimension data does not exist, inserting a row of dimension data into a dimension table related to the fact table through the foreign key.

### BACKGROUND OF THE INVENTION

1. Field of the Invention

The field of the invention is data processing, or, more specifically, methods, systems, and products for populating a database using inferred dependencies.

2. Description of Related Art

Because a first database is too large to work with in a development and test environment, or because a first database is too large for efficient use in some kinds of data analysis, it is often useful to create in a second database a portion of a first database. The schema of the first database typically is duplicated in the second database, and the problem becomes how to create a subset of the first database's data tables in the second database. The task is complicated by the fact while the first database is known to have referential integrity effected by enforcement of the constraints associated with foreign keys through a database management system (“DBMS”), and it is useful also for the second database to have such referential integrity.

To insert rows in tables in a database with referential integrity checks against foreign keys, a data conversion routine maybe allowed to insert data with the target DBMS's integrity checks turned off. Then a further check must be made to attempt to assure that that all the necessary rows exist before turning integrity checking back on. This approach requires little knowledge of the integrity constraints on the part of the programmer of the conversion routines, but it risks inserting data that violates integrity constraints.

Alternatively, data conversion may be carried out with integrity checking on, in which case, the data conversion routines must be carefully programmed to insert rows in tables in dependency order, so that no particular insertion of a row in a table is attempted before all of the row's required foreign keys are inserted. This approach reduces the risk of integrity violations, but it requires that the programmer of the conversion routines have comprehensive knowledge of the integrity constraints, a laborious requirement in dealing with large databases.

When tables referenced by foreign keys are small, it is possible to copy all the tables needed for reference by central fact tables to the target database first and then select some number of rows from the fact tables to bring over. Since all the reference data is already there in the target, the selection of rows from fact tables will have everything they need for their foreign keys to point to, and the conversion may proceed with conversion checking turned on. Possibly there are more rows in the reference tables than are necessary, but that may not be problematic if they are small.

On the other hand, in some cases, the reference tables (the ‘dimensional tables,’ in OLAP terminology) are not so much lookup tables for common values as they are further storage for what amounts in effect to additional fact data. Thus, while the core fact tables are large, the dimension tables can be truly huge. In this circumstance in particular it is clear that it would be advantageous to have a method of inserting into the target database only those rows of dimension data or reference data actually needed by supported rows in fact tables, regardless whether integrity checking is on or off in the target database. For all these reasons, there is an ongoing need for improved methods of inserting data in databases subject to integrity constraints.

### SUMMARY OF THF INVENTION

Methods, systems, and computer program products are disclosed for populating a database, typically including providing a database having a schema; inferring from the schema dependencies among a fact table and related dimension tables; and inserting in accordance with the dependencies, rows of data into the fact table and rows of data into the dimension tables. In typical embodiments, a dependency comprises a rule for the database, enforced by a database management system, that a first record in a first table must exist in the database before a second record in a second table maybe inserted in the database. In typical embodiments, inferring dependencies includes selecting from metadata describing a schema for the database expressions of dependencies and inserting the expressions of dependencies into a dependency list.

In typical embodiments, inserting rows of data includes determining whether related dimension data exists for each foreign key in each row of data inserted into the fact table and for each foreign key for which related dimension data does not exist, inserting a row of dimension data into a dimension table related to the fact table through the foreign key. In typical embodiments, inserting rows of data also typically includes determining whether related dimension data exists for each foreign key in each row of data inserted into a first dimension table and for each foreign key for which related dimension data does not exist, inserting a row of dimension data into a second dimension table related to the first dimension table through the foreign key. In typical embodiments, inserting rows of data further comprises reading the rows of data from a first database, the first database comprising dependencies among tables in the database and inserting rows of data into a second database, the second database comprising at least the same dependencies as the first database.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THF DRAWINGS

FIG. 1 sets forth a table relations diagram illustrating a fact table related to several dimension tables according to an exemplary star schema useful with various embodiments of the current invention.

FIG. 2 sets forth a table relations diagram illustrating a fact table related to several dimension tables according to an exemplary snowflake schema useful with various embodiments of the current invention.

FIG. 3 sets forth a data flow diagram illustrating an exemplary method for populating a database according to one embodiment of the present invention.

### DETAILED DESCRIPTION OF EXEMPLARY EMBODIMENTS

The present invention is described to a large extent in this specification in terms of methods for populating a database using inferred dependencies. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of information, typically represented as digital data. Aggregates of data elements are referred to as “records” or “data structures.” Aggregates of records are referred to as “tables” or “files.” Aggregates of files or tables are referred to as “databases.” In the context of tables, fields maybe referred to as “columns,” and records may be referred to as “rows.” Complex data structures that include member methods, functions, or software routines as well as data elements are referred to as “classes.” Instances of classes are referred to as “objects” or “class objects.”

“OLAP” abbreviates ‘OnLine Analytical Processing,’ a category of software tools that provides analysis of data in databases. OLAP standards and benchmarks for OLAP servers are promulgated by an industry organization known as ‘The OLAP Council.’ OLAP tools enable users to analyze multidimensional data. OLAP often is used in data mining and in conjunction with data warehouses. The chief component of OLAP is an OLAP server that possesses a schema or specification for organization of data in a database and has special functions for analyzing the data. OLAP servers are available for most major database systems.

In this specification, the terms ‘fact table’ and ‘dimension table’ are used as they are used generally in OLAP terminology. The term ‘fact table’ refers to tables bearing measures, that is, tables bearing actual measured data values for an attribute represented in data. ‘Dimension tables’ are tables bearing referential integrity values for foreign keys in fact tables.

An OLAP server may either physically stage data for delivery to end users, or it may populate its data structures in real-time from other databases, or offer a choice of both. For consistent and rapid response times, staging data in the OLAP server itself is often preferred. The fact that this specification uses the terms ‘fact table’ and ‘dimension table’ as they are used generally in OLAP terminology, however, is not a limitation of the invention regarding the location of data. That is, a target database to be populated with data according to embodiments of the present invention may be an OLAP database on an OLAP server, it may be a database served by an OLAP server, or it may have nothing whatsoever to do with an OLAP server. The terms ‘fact table’ and ‘dimension table’ are used to explain relations among tables and integrity constraints in databases. They are borrowed from OLAP terminology, purely for convenience of explanation. Their use here does not require OLAP.

“Pseudocode” refers to code-like examples used for explanation rather than as depictions of actual working models. In this disclosure, purely for explanation and not for limitation of the invention, pseudocode examples are generally expressed in syntax similar to the Structured Query Language (“SQL”) and the Perl programming language. There is no limitation of the invention to these languages, however. On the contrary, the methods of the invention may be expressed and carried out by use of many other languages as will occur to those of skill in the art, and the use of all such languages is well within the scope of the present invention.

“Schema” refers to the structure of a database. A schema in a typical DBMS is stored in metadata, often in a data dictionary, and typically is described in some formal language supported by a DBMS. In relational databases, schemas define the tables, the fields in each table, relationships between fields and tables (foreign keys), as well as dependencies, constraints of referential integrity. In this disclosure, the terms ‘dependency’ and ‘constraint,’ subject to context, generally are used as synonyms.

“SQL” stands for ‘Structured Query Language,’ a standardized query language for requesting information from a database. Although there is an ANSI standard for SQL, as a practical matter, most versions of SQL tend to include many extensions. This specification provides examples of one or more database queries expressed as pseudocode SQL. Such examples are said to be ‘pseudocode’ because they are not cast in any particular version of SQL and also because they are presented for purposes of explanation rather than as actual working models.

### Populating a Target Database

Typical methods of populating a target database according to embodiments of the present invention proceed by reading rows from a fact table in a source database and inserting them into a corresponding table in a target database, having first inserted the necessary rows into the tables for which the fact table bears foreign key dependencies. The target database may or may not have exactly the same schema as the source database. If the target database does not have exactly the same the schema as the source database, however, the target database does have a schema that includes at least the dependencies needed for referential integrity of the data to be transferred.

In typical systems according to embodiments of the present invention, a schema describes a relational implementation of a multidimensional table design as is normally used for OLAP data storage and which is commonly referred to as a “star schema” (a central fact table containing mostly columns whose values are foreign keys or pointers to rows in other so-called ‘dimension’ tables which are envisioned as surrounding the fact table) or a “snowflake schema” (similar to the star, but the dimension tables themselves contain foreign keys to other reference tables in the more usual pattern of a normalized relational schema). Persons of skill in the art will immediately recognize that it is possible within the scope of the present invention, that instead of two separate databases serving as source and target, there may be two schemas in a single database.

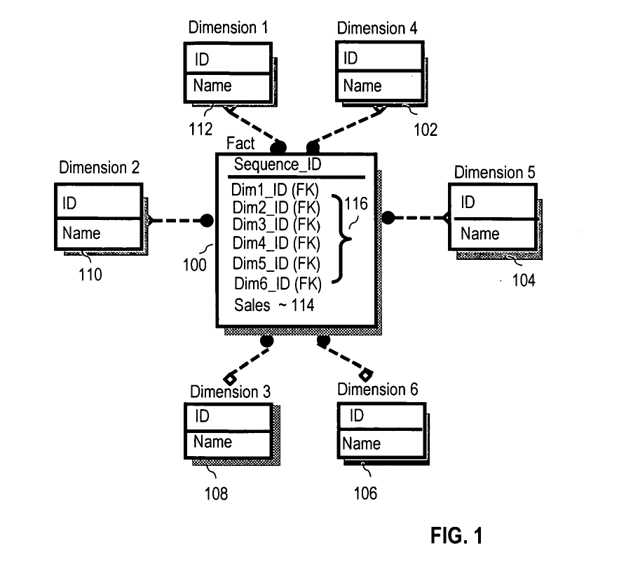

In typical systems according to embodiments of the present invention, a fact table records some conjunction of rows from dimension tables as a description of some event, plus some important value as a measure of something of interest that occurred during that event (e.g. value of the sale). FIG. 1 sets forth a table relations diagram illustrating a fact table (100) related to several dimension tables (102-112) according to an exemplary star schema useful with various embodiments of the current invention. In particular, the fact table (100) is related to the dimension tables (102-112) through foreign keys (116), each of which identifies a value in a dimension table. In this example, the rows in the fact table (100) represent sales of goods, and the sales field (114) in each row of the fact table represents the dollar amount of a sale. Rows in the dimension tables represent permissible values of attributes of sales, such as, for example, identification codes for items sold, locations of points of sale, sales account identifications, company and sales department identifications, accounting periods, customer identification codes for purchasers, sales type codes (credit or cash, for example), and so on.

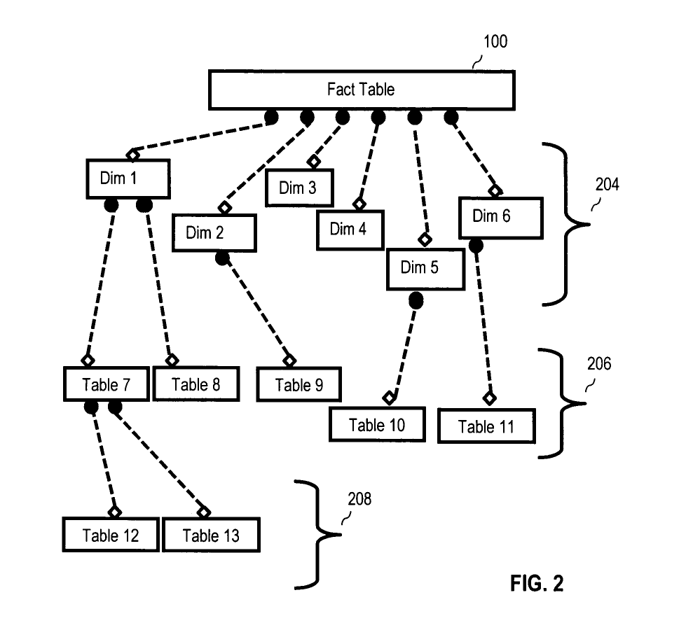

A snowflake schema, then, is a star schema where the dimension tables themselves contain foreign keys to other tables (and those tables may be keyed to still other tables, and so on.) FIG. 2 sets forth a table relations diagram illustrating a fact table (100) related to several dimension tables (204) according to an exemplary snowflake schema useful with various embodiments of the current invention. The fact table (100) is related to the dimension tables (102-112) through foreign keys (not shown). In this example, several of the dimension tables in the first relations level (204) below the fact table (100) are themselves further related to additional dimension tables in a second level (206) below the fact table, and one of the dimension tables in the second level (Table 7) is even further related to two additional dimension tables (Tables 12 and 13) in a third level (208) below the fact table. The use of three levels in this example is for explanation. Persons of skill in the art will recognize that there is no limit in principle on the number of levels of among which dimension tables may be related in a snowflake schema.

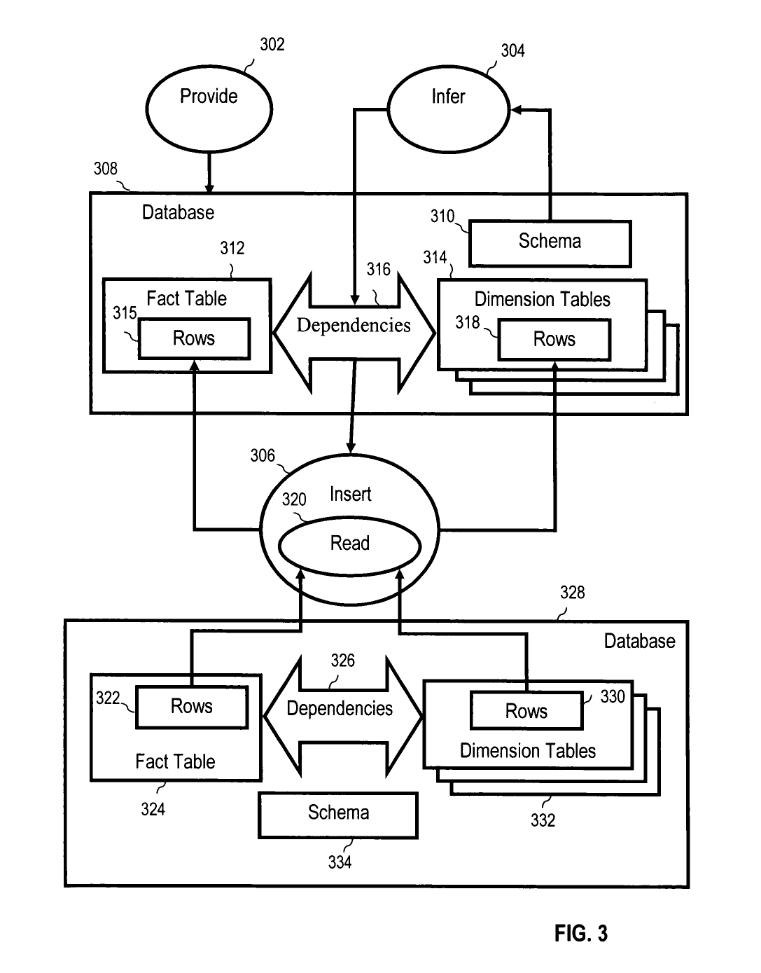

FIG. 3 sets forth a data flow diagram illustrating an exemplary method for populating a database according to one embodiment of the present invention that includes providing (302) a database (308) having a schema (310). In this example, the database (308) is a target database to be populated with data from a source database, shown in this example as database (328). The schema (310) is a metadata representation of the structure of database (308) supported by a DBMS (not shown) under which database (308) is administered. In this example, schema (310) defines the tables in database (308) as well as the fields in the each table, relationships between fields and tables (foreign keys), and dependencies among tables, that is, constraints of referential integrity.

### Inferring Dependencies

The exemplary method of FIG. 3 includes inferring (304) from the schema (310) dependencies (316) among a fact table (312) and related dimension tables (314). Inferring (304) dependencies (316) is carried out typically according to embodiments of the present invention by selecting from metadata describing a schema for the database expressions of dependencies and inserting the expressions of dependencies into a dependency list. In the example of FIG. 3, a dependency comprises a rule for the database (308), enforced by a database management system (not shown), that a first record in a first table must exist in the database before a second record in a second table may be inserted in the database. The expressions of dependencies typically comprise tables names and column names describing foreign keys, that is, foreign keys relating tables (such as fact table (312)) in which certain records are to be inserted to other tables (such as the dimension tables (314)) in which records must exist before the certain records are inserted.

Some methods of inferring (304) dependencies (316) include calling recursive SQL queries. It is useful to recognize that the tables in a snowflake (to use the more general case) schema are related (approximately) in a graph structure known as a tree, where a fact table may be taken as the root, and the relations to the other tables (typically dimension tables, in OLAP parlance) form the branches. That is, the other tables are located at ‘nodes’ of the tree. The last unconnected nodes (tables) at the ends of a sequence of connections are called ‘leaves.’ Such a tree is generally thought of (in computer science and graph theory) as upside-down compared to normal trees, so the root is at the top, and the leaves are at the bottom. One of the properties things in a tree have is ‘depth,’ which is defined as the number of connections it takes to hop back to the root. In this disclosure, ‘depth’ of a branch or leaf in a tree structure is often referred to as ‘level.’ The illustration of the snowflake schema in FIG. 2 also illustrates the tree-like quality of such schema.

Gathering information about a tree involves ‘traversing’ the tree, visiting each node, (branch or leaf) of the tree in turn and gathering information about it and about its relation to the other nodes in the tree, i.e., its connection to the tree. One wayto traverse a tree is with an algorithm that can call itself—a recursive algorithm. Some SQL implementations, including for example DB2's SQL, now support recursively structured SELECT statements. The examples discussed in this disclosure generally take advantage of that ability.

It is an unfortunate accident of nomenclature that when defining referential constraints, the ‘parent’ table refers to the table containing the row that must exist before the row in the ‘child’ table can be inserted, which means that the parents are below their children in a graph like the one shown in FIG. 2. It is common usage when talking about trees as data structures, however, to use the term ‘parent,’ in discussing two related nodes, to refer to the node closer to the root, i.e., the one above the other in the tree. So it is useful to exercise some caution in order to reduce the risk of confusion. In this disclosure, the terms ‘parent’ and ‘child’ are used generally in database parlance rather than according to graph theory.

More particularly, inferring (304) from the schema (310) dependencies (316) among a fact table (312) and related dimension tables (314) maybe carried out as illustrated by the following pseudocode SQL statement:

WITH dependencyList (PTable, PCol, CTable, CCol, Level) as
(

| | | |
|---|---|---|
| SELECT | ref.REFTABNAME as PTable, | |
| | keycol1.COLNAME as PCol, | |
| | keycol2.TABNAME as CTable, | |
| | keycol2.COLNAME as CCol, | |
| | 0 as Level | |
| FROM | SYSCAT.REFERENCES ref, | |
| | SYSCAT.KEYCOLUSE keycol1, | |
| | SYSCAT.KEYCOLUSE keycol2 | |
| WHERE | ref.TABSCHEMA = ‘NETMINE’ | AND |
| | ref.TABNAME = ‘SA_FACT’ | AND |
| | ref.CONSTNAME = keycol2.CONSTNAME | AND |
| | ref.TABSCHEMA = keycol2.TABSCHEMA | AND |
| | ref.TABNAME = keycol2.TABNAME | AND |
| | keycol2.COLSEQ = 1 | AND |
| | ref.REFKEYNAME = keycol1.CONSTNAME | AND |
| | ref.REFTABSCHEMA = keycol1.TABSCHEMA | AND |
| | ref.REFTABNAME = keycol1.TABNAME | AND |
| | keycol1.COLSEQ = 1 | |
| UNION ALL | | |
| SELECT | ref.REFTABNAME as PTable, | |
| | keycol1.COLNAME as PCol, | |
| | keycol2.TABNAME as CTable, | |
| | keycol2.COLNAME as CCol, | |
| | DL.Level + 1 as Level | |
| FROM | DependencyList DL, | |
| | SYSCAT.REFERENCES ref, | |
| | SYSCAT.KEYCOLUSE keycol1, | |
| | SYSCAT.KEYCOLUSE keycol2 | |
| WHERE | ref.TABSCHEMA = ‘NETMINE’ | AND |
| | ref.TABNAME = DL.PTable | AND |
| | ref.CONSTNAME = keycol2.CONSTNAME | AND |
| | ref.TABSCHEMA = keycol2.TABSCHEMA | AND |
| | ref.TABNAME = keycol2.TABNAME | AND |
| | keycol2.COLSEQ = 1 | AND |
| | ref.REFKEYNAME = keycol1.CONSTNAME | AND |
| | ref.REFTABSCHEMA = keycol1.TABSCHEMA | AND |
| | ref.REFTABNAME = keycol1.TABNAME | AND |
| | keycol1.COLSEQ = 1 | AND |
| | DL.Level < 4 | |
| | -- There's a circular reference in the schema we're using: | |
| | -- Category_names.Parent -> Category_names.ID | |
| | -- So limit the query by conditioning Level to < 4 (really <=4) | |
| ) | | |

```
SELECT PTable, PCol, CTable, CCol, Level
  FROM dependencyList
  GROUP BY PTable, PCol, CTable, CCol, Level
  ORDER BY Level, CTable;
```

In this example, the clause:
WITH dependencyList (PTable,PCol,CTable,CCol,Level) as (
   constructs a temporary table called ‘dependencyList’ that contains all the columns in a desired result set:
Ptable, the parent table involved in the relation
Pcol, the column in the parent table
Ctable, the child table involved,
Ccol, the column in the child table
Level, the Level (or depth) of the cChild table (that is, the constraint's child, the child in the dependency, thus, the upper node in the tree). For the root node (the Fact table) the Level is 0. As the recursion progresses, the level is incremented.

The example SQL continues with three SELECT statements and a UNION ALL statement. The UNION ALL is a signal to a SQL query compiler that the SQL statement may define a recursion, more particularly, that the first two SELECTS in this example may define a recursion.

In the example, the first SELECT statement:

| | | |
|---|---|---|
| SELECT | ref.REFTABNAME as PTable, | |
| | keycol1.COLNAME as PCol, | |
| | keycol2.TABNAME as CTable, | |
| | keycol2.COLNAME as CCol, | |
| | 0 as Level | |
| | -- 0 level indicates the child table is a root of | |
| | the expansion | |
| FROM | SYSCAT.REFERENCES ref, | |
| | SYSCAT.KEYCOLUSE keycol1, | |
| | SYSCAT.KEYCOLUSE keycol2 | |
| WHERE | ref.TABSCHEMA = ‘NETMINE’ | AND |
| | ref.TABNAME = ‘SA_FACT’ | AND |
| | ref.CONSTNAME = keycol2.CONSTNAME | AND |
| | ref.TABSCHEMA = keycol2.TABSCHEMA | AND |
| | ref.TABNAME = keycol2.TABNAME | AND |
| | keycol2.COLSEQ = 1 | AND |
| | ref.REFKEYNAME = keycol1.CONSTNAME | AND |
| | ref.REFTABSCHEMA = keycol1.TABSCHEMA | AND |
| | ref.REFTABNAME = keycol1.TABNAME | AND |
| | keycol1.COLSEQ = 1 | |

adds all the constraints on the Level 0 table (the fact table in this example) to the temporary table ‘dependencyList.’ Setting Level to 0 in the initial SELECT indicates that the child table for the SELECT is a root of the expansion.

The second SELECT statement:

| | | |
|---|---|---|
| SELECT | ref.REFTABNAME as PTable, | |
| | keycol1.COLNAME as PCol, | |
| | keycol2.TABNAME as CTable, | |
| | keycol2.COLNAME as CCol, | |
| | DL.Level + 1 as Level | |
| FROM | DependencyList DL, | |
| | SYSCAT.REFERENCES ref, | |
| | SYSCAT.KEYCOLUSE keycol1, | |
| | SYSCAT.KEYCOLUSE keycol2 | |
| WHERE | ref.TABSCHEMA = ‘NETMINE’ | AND |
| | ref.TABNAME = DL.PTable | AND |
| | ref.CONSTNAME = keycol2.CONSTNAME | AND |
| | ref.TABSCHEMA = keycol2.TABSCHEMA | AND |
| | ref.TABNAME = keycol2.TABNAME | AND |
| | keycol2.COLSEQ = 1 | AND |
| | ref.REFKEYNAME = keycol1.CONSTNAME | AND |
| | ref.REFTABSCHEMA = keycol1.TABSCHEMA | AND |
| | ref.REFTABNAME = keycol1.TABNAME | AND |
| | keycol1.COLSEQ = 1 | AND |
| | DL.Level < 4 | |

starts with the results gathered so far by the first select. It takes the first row in the results set from the temporary table ‘dependencyList’ (all rows that match the where clause criteria, of which only the last criterion refers to something in the temporary table) and uses it to generate more rows. Those rows are added to the end of the temporary table ‘dependencyList’ and to the end of the result set. Their Level column is incremented. When it finishes with one row, it uses the next one in the results set, which will result in more rows being added. When it finishes with all the rows that were in the result set from the first select, it finds more rows—those that have been added in the meantime. Thus, rows could very well be added by this second SELECT and also used by the second SELECT. Because the tree is finite, however, the number of constraints that define the tree is finite, and eventually the SELECT, generally speaking, will run out of rows in the result set and finish.

That is, the SELECT will eventually run out of rows in the result set and finish unless constraints are defined from a table to itself or from one table to another table above it in the tree. This creates a ‘cycle’ and strictly speaking violates the usual rules of a tree structure which are usually supposed to define a so-called ‘acyclic graph.’ Despite the unconventional nature of cyclic graphs, nevertheless, it is possible for them to occur in a database constraint list. So, as a result of experimentation with this exemplary schema, a predicate is added in the second SELECT on the Level column in the result set to prevent cycles from causing non-ending recursions: DL.Level <4. In fact, in the exemplary dependencies set forth in the further discussion below, there exists a circular reference or cyclic graph effect in that Category_names.Parent depends on the existence of Category_names.ID, so that limiting the query SELECT WHERE clause by conditioning Level to <4 (effectively <=4) is useful.

The third SELECT:

```
SELECT PTable, PCol, CTable, CCol, Level
    FROM dependencyList
    GROUP BY PTable, PCol, CTable, CCol, Level
    ORDER BY Level, CTable;
```

just picks out from dependencyList the entire temporary table just created by the other two SELECTs.

In addition to the possibility of cyclic graphs in dependencies, it is possible (indeed quite likely in practice) for a given table—one that is a commonly used reference table or dimension table—to exist at more than one node in a tree structure representing dependencies. The constraints that descend from such a table therefore will be listed more than once in the result set of the example SQL query. In the third SELECT, the GROUP BY clause:
GROUP BY PTable, PCol, CTable, CCol, Level
   eliminates the duplicates arising from a reference table being reference multiple times by a fact table—basically a SQL “select distinct” on multiple columns.

The ORDER BY clause in the third SELECT:
ORDER BY Level, CTable;
   assures the application code that calls the SQL statement that the dependency list starts at the root of the tree (that is, at the fact table) and works down and that the constraints on a given table at a given level are all together. The GROUP BY does not purport to eliminate duplicate dependencies on a reference table or dimension table that is used at different levels, although in the algorithm described below for inserting data in a target database, this just means that ensuing attempts to satisfy such dependencies will find them already satisfied from an earlier attempt, so that there is harm other than a few extra lookups.

The following dependencies list is a table comprising an example of the results of a call to the example SQL statement discussed above:

Dependencies List

| | Parent | | | |
|---|---|---|---|---|
| Parent Table | Column | Child Table | Child Column | Level |
| COOKIE_NAMES | ID | SA_FACT | COOKIE | 0 |
| DATE_VALUES | ID | SA_FACT | DATE_ID | 0 |
| HOST_NAMES | ID | SA_FACT | HOSTNAME | 0 |
| PROTOCOL_NAMES | ID | SA_FACT | PROTOCOL | 0 |
| REFCGI_Q_NAMES | ID | SA_FACT | REF_CGI_PARMS | 0 |
| REFCGI_Q_NAMES | ID | SA_FACT | VISIT_REF_{—} | 0 |
| | | | CGI_PARMS | |
| RESCGI_Q_NAMES | ID | SA_FACT | RES_CGI_PARMS | 0 |
| RESCGI_Q_NAMES | ID | SA_FACT | VISIT_ENTRY_RES_CGI | 0 |
| RESCGI_Q_NAMES | ID | SA_FACT | VISIT_EXIT_RES_CGI | 0 |
| TIME_VALUES | ID | SA_FACT | TIME_ID | 0 |
| USER_NAMES | ID | SA_FACT | USER_IDENTIFIER | 0 |
| USERAGENT_NAMES | ID | SA_FACT | USERAGENT | 0 |
| VISIT_TYPE_{—} | ID | SA_FACT | VISIT_TYPE_ID | 0 |
| COLLECTION | | | | |
| SUBDOMAIN_NAMES | ID | HOST_NAMES | SUBDOMAIN_ID | 1 |
| CATEGORY_NAMES | ID | REFCGI_Q_NAMES | CATEGORY_13_ID | 1 |
| REFERRAL_NAMES | ID | REFCGI_Q_NAMES | REFERRAL_ID | 1 |
| SEARCH_ENGINES | ID | REFCGI_Q_NAMES | SEARCH_ENGINE_ID | 1 |
| SEARCHENGINE_{—} | ID | REFCGI_Q_NAMES | SEARCH_ENGINE_KW_ID | 1 |
| KEYWORD | | | | |
| CATEGORY_NAMES | ID | RESCGI_Q_NAMES | CATEGORY_1_ID | 1 |
| CATEGORY_NAMES | ID | RESCGI_Q_NAMES | CATEGORY_3_ID | 1 |
| CATEGORY_NAMES | ID | RESCGI_Q_NAMES | CATEGORY_8_ID | 1 |
| CATEGORY_NAMES | ID | RESCGI_Q_NAMES | CATEGORY_9_ID | 1 |
| RESOURCE_NAMES | ID | RESCGI_Q_NAMES | RESOURCE_ID | 1 |
| BROWSER_NAMES | ID | USERAGENT_NAMES | BROWSER_ID | 1 |
| PLATFORM_NAMES | ID | USERAGENT_NAMES | PLATFORM_ID | 1 |
| VISIT_TYPE | ID | VISIT_TYPE_{—} | TYPE_ID_1 | 1 |
| | | COLLECTION | | |
| VISIT_TYPE | ID | VISIT_TYPE_{—} | TYPE_ID_2 | 1 |
| | | COLLECTION | | |
| CATEGORY_{—} | ID | BROWSER_NAMES | CATEGORY_5_ID | 2 |
| NAMES | | | | |
| CATEGORY_{—} | ID | PLATFORM_NAMES | CATEGORY_4_ID | 2 |
| NAMES | | | | |
| CATEGORY_{—} | ID | REFERRAL_NAMES | CATEGORY_2_ID | 2 |
| NAMES | | | | |
| REFERRALHOST_{—} | ID | REFERRAL_NAMES | HOSTID | 2 |
| NAMES | | | | |
| CATEGORY_{—} | ID | SEARCHENGINE_{—} | CATEGORY_14_ID | 2 |
| NAMES | | KEYWORD | | |
| CATEGORY_{—} | ID | SUBDOMAIN_NAMES | CATEGORY_6_ID | 2 |
| NAMES | | | | |
| DOMAIN_NAMES | ID | SUBDOMAIN_NAMES | DOMAIN_ID | 2 |
| CATEGORY_{—} | ID | DOMAIN_NAMES | CATEGORY_7_ID | 3 |
| NAMES | | | | |

Each row of the example Dependencies List table represents a constraint or dependency in a database having the tables and columns named in the table. The first row, for example, represents the constraint that before adding a row in a table named SA_FACT, a value for the foreign key field named COOKIE must exist in a field named ID in a dimension or reference table named COOKIE_NAMES. The second row in the Dependencies List table, represents the constraint that before adding a row in a table named SA_FACT, a value for the foreign key field named DATE_ID must exist in a field named ID in a dimension or reference table named DATE_VALUES. The third row in the Dependencies List table represents the constraint that before adding a row in a table named SA_FACT, a value for the foreign key field named HOSTNAME must exist in a field named ID in a dimension or reference table named HOST_NAMES. And so on, for all the rows in the Dependencies List table. The fact that all the parent column names in the Dependencies List table is arbitrary for this example. The parent column names can be anything.

Note the multiple dependencies on REFCGI_Q_NAMES and on RESCGI_Q_NAMES. Recall that in this example, it was the GROUP BY clause in the third SELECT in the SQL statement that prevented multiple sets of dependencies between the same child tables at the same level. Also in this example, the CATEGORY_NAMES table has a circular reference defined on it, and some post-checking is therefore useful to determine that the Level <4 predicate, which prevents runaway recursion, does not exclude dependencies that are needed.

### Inserting Row of Data

The exemplary method of FIG. 3 includes inserting (306), in accordance with the dependencies (316), rows (316) of data into the fact table (312) and rows (318) of data into the dimension tables (318). In the kind of method illustrated in FIG. 3, inserting (306) rows (316, 318) of data typically includes determining whether related dimension data exists for each foreign key in each row of data inserted into the fact table and, for each foreign key for which related dimension data does not exist, inserting a row of dimension data into a dimension table related to the fact table through the foreign key. In the method according to FIG. 3, inserting (306) rows (316, 318) of data further is further carried out by determining whether related dimension data exists for each foreign key in each row of data inserted into a first dimension table, and, for each foreign key for which related dimension data does not exist, inserting a row of dimension data into a second dimension table related to the first dimension table through the foreign key. Because dependencies are often amenable to expression in tree structures and because recursion is a natural algorithmic technique for dealing with tree structures, inserting rows of fact data, first checking each foreign key against a dimension table and if a required dimension row does not exist, inserting it, first checking each foreign key in it against a further dimension table and if a required dimension row does not exist, inserting it, first checking . . . may often be effected by use of recursion, as described in more detail below.

In the exemplary method of FIG. 3, inserting (306) rows (316, 318) of data further comprises reading (320) the rows of data from a first database (328), the first database comprising dependencies (326) among tables in the database and inserting rows of data into a second database (308), the second database comprising at least the same dependencies as in the first database. That is, within the scope of the present invention, the source of data to be inserted in a target database can be any source, anywhere, not just another database. As a practical matter, however, method of populating databases according to embodiments of the present invention will often be carried out by drawing their source data from another database. It is useful to recognize, however, that the schema of the target database need not be the same as the schema of the source database, so long as the dependencies expressed in the schema of the target database include at least sufficient dependencies to maintain desired referential integrity in the target database as it is populated according to embodiments of the present invention.

More particularly, inserting (306), in accordance with the dependencies (316), rows (316) of data into a fact table (312) and rows (318) of data into dimension tables (318) may be carried out as illustrated by the following exemplary pseudocode segment:

```
RowsAdded = 0;
RowsWanted = 6000
// create new TableDependencies as a subset of dependencyList
TableDependencies = newTableDependencies(tableName SA_FACT);
while (RowsAdded < RowsWanted) do {
    read next SourceDB.SA_FACT row into Row;
    call ensureDependencies (Row, TableDependencies);
    add Row to TargetDB.SA_FACT;
    RowsAdded++;
}
```

The call to newTableDependencies(tableName) creates a subset of the list of dependencies (see above) where the Child Table name is tableName, in this example set to “SA_FACT.” This subset list TableDependencies is passed as one of the parameters to ensureDependencies( ), whose job is to determine that each dependency in the list is met for the all the foreign keys in a fact row—either by checking and finding the right value in the right column in the parent table—or by going to the source database to get the row it needs and inserting it in the parent table if it is not already there.

Here is a pseudocode example for ensureDependencies( ):

```
ensureDependencies (Row, Dependencies) {
  while((nd = getNextDependency(Dependencies)) != null) {
    // nd now points to a current dependency record, so that
    // nd.parentTableName references the parent table name
    // of the current dependency, nd.parentColumnName
    // references the parent column name of the current
    // dependency, and so on.
    // get the key value in Row required to be in
    // ParentTableName.ColumnName before the Row can
    // be added to the child table.
    keyValue = getNextKeyValue(Row);
    // lookup KeyValue in ParentTableName.ColumnName
    // in TargetDB
    if((kv = findKeyValue(keyValue,
      targetDB.ParentTableName.ColumnName)) != null)
      // if the keyValue already exists, the dependency is
      // met, so do nothing:
      ;
    else {
      // if the keyValue does not yet exist, create a row for
      // it in ParentTableName.ColumnName.
      lookup (KeyValue) in ParentTableName in SourceDB
      to get DimensionRow;
      create a newTableDependencies(ParentTableName) as
      subset of DependencyList where the Child Table is now
      ParentTableName;
      call /* recursively */ ensureDependencies
      (DimensionRow, newTableDependencies);
      // When the (recursive) call returns, the dependencies
      // are all met for this row and it can be added
      // to ParentTableName.
      add DimensionRow to ParentTableName in TargetDB;
    }
    remove Dependency from Dependencies;
  } // end while: If there is no next dependency, return.
}
```

For further explanation, assume a snowflake schema database from which it is desired to extract a subset of five rows of fact data plus all the reference or dimension rows needed in the surrounding tables. Here are the intended five rows of fact table data:

| DATE_ID | TIME_ID | PROTOCOL | RES_CGI_PARMS | REF_CGI_PARMS | COOKIE | BYTES |
|---|---|---|---|---|---|---|
| 92 | 39334 | 1 | 9738882 | 1974101 | 2478241 | 0 |
| 92 | 69198 | 1 | 4426097 | 11385 | 0 | 0 |
| 92 | 45990 | 2 | 1880139 | 55324 | 1004438 | 0 |
| 92 | 41486 | 1 | 10091509 | 59246 | 0 | 5 |
| 92 | 64434 | 1 | 10091054 | 59438 | 0 | 5 |

In this example, the Bytes column is a measure, and all other columns are keys to dimension tables. After running a SQL query to infer the dependencies, the initial dependencies are these:

| | Parent | | | |
|---|---|---|---|---|
| Parent Table | Column | Child Table | Child Column | Level |
| COOKIE_NAMES | ID | FACT | COOKIE | 0 |
| DATE_VALUES | ID | FACT | DATE_ID | 0 |
| PROTOCOL_NAMES | ID | FACT | PROTOCOL | 0 |
| REFCGI_Q_NAMES | ID | FACT | REF_CGI_PARMS | 0 |
| RESCGI_Q_NAMES | ID | FACT | RES_CGI_PARMS | 0 |
| TIME_VALUES | ID | FACT | TIME_ID | 0 |
| CATEGORY_NAMES | ID | REFCGI_Q_NAMES | CATEGORY_13_ID | 1 |
| REFERRAL_NAMES | ID | REFCGI_Q_NAMES | REFERRAL_ID | 1 |
| SEARCH_ENGINES | ID | REFCGI_Q_NAMES | SEARCH_ENGINE_ID | 1 |
| SEARCHENGINE_{—} | ID | REFCGI_Q_NAMES | SEARCH_ENGINE_K | 1 |
| KEYWORD | | | | |
| CATEGORY_NAMES | ID | RESCGI_Q_NAMES | CATEGORY_1_ID | 1 |
| CATEGORY_NAMES | ID | RESCGI_Q_NAMES | CATEGORY_3_ID | 1 |
| CATEGORY_NAMES | ID | RESCGI_Q_NAMES | CATEGORY_8_ID | 1 |
| CATEGORY_NAMES | ID | RESCGI_Q_NAMES | CATEGORY_9_ID | 1 |
| RESOURCE_NAMES | ID | RESCGI_Q_NAMES | RESOURCE_ID | 1 |
| CATEGORY_NAMES | ID | REFERRAL_NAMES | CATEGORY_2_ID | 2 |
| REFERRALHOST_{—} | ID | REFERRAL_NAMES | HOSTID | 2 |
| NAMES | | | | |
| CATEGORY_NAMES | ID | SEARCHENGINE_KEYWORD | CATEGORY_14_ID | 2 |

Extracting subset of dependencies taking the fact table named “FACT” as the child yields:

| Parent Table | Parent Column | Child Table | Child Column | Level |
|---|---|---|---|---|
| COOKIE_NAMES | ID | FACT | COOKIE | 0 |
| DATE_VALUES | ID | FACT | DATE_ID | 0 |
| PROTOCOL_NAMES | ID | FACT | PROTOCOL | 0 |
| REFCGI_Q_NAMES | ID | FACT | REF_CGI_PARMS | 0 |
| RESCGI_Q_NAMES | ID | FACT | RES_CGI_PARMS | 0 |
| TIME_VALUES | ID | FACT | TIME_ID | 0 |

Taking the first fact row in the result set, each of these six dependencies has to be ensured before the fact row can be added to the target database: the Child Column value for each dependency row has to be found as a value for ParentTable.ParentColumn—either because it was already there, or because it has been added—before the row can be inserted. So this example calls ensureDependencies( ) passing as parameters the first row of values and the dependencies subset.

EnsureDependencies( ) begins with the COOKIE column, with the value 2478241. Since this is the beginning of processing, obviously the foreign key value is not going to be found existing already as a value for COOKIE.NAMES.ID in the target database, so the source database is queried for a corresponding dimension row. Before new COOKIE_NAMES row can be added, its dependencies must be checked So a subset of Dependencies whose Child_Table is COOKIE_NAMES is formed (which happens to be empty), and ensureDependencies( ) is called recursively with that empty subset and the COOKIE_NAMES row. Now ensureDependencies( ) returns quickly (having nothing to do), and the new row for COOKIE_NAMES is inserted into the target database. The COOKIE dependency is dropped from the dependencies subset, and ensureDependencies( ) loops on the remaining records in the dependencies subset, if any.

The processing for foreign keys DATE_ID and PROTOCOL is the same as for COOKIE, but processing for REF_CGI_PARMS is different. There is a value for REF_CGI_PARMS, and again not finding it in the target REFCGI_Q_NAMES table, ensureDependencies( ) retrieves its corresponding row from the source database table. But now upon inferring the new subset of dependencies for REFCGI_Q_NAMES, the routine finds it to be non-empty. It contains these entries:

| | | | | |
|---|---|---|---|---|
| CATEGORY_NAMES | ID | REFCGI_Q_NAMES | CATEGORY_13_ID | 1 |
| REFERRAL_NAMES | ID | REFCGI_Q_NAMES | REFERRAL_ID | 1 |
| SEARCH_ENGINES | ID | REFCGI_Q_NAMES | SEARCH_ENGINE_ID | 1 |
| SEARCHENGINE_KEYWORD | ID | REFCGI_Q_NAMES | SEARCH_ENGINE_KW_ID | 1 |

So now the routine needs to assure that these dependencies also are met. The retrieved row in the source REFCGI_Q_NAMES table contains the following data:

| | | | SEARCH_{—} | SEARCH_{—} | CATEGORY_{—} |
|---|---|---|---|---|---|
| ID | NAME | REFERRAL_ID | ENGINE_ID | ENGINE_KW_ID | 13_ID |
| 197401 | no_referral | 8548856 | 0 | 0 | 3139 |

The value 3139 is a foreign key to the target CATEGORY_NAMES table and is not found. So the dependency subset for CATEGORY_NAMES is formed and the source table row with 3139 in the source CATEGORY_NAMES is found and retrieved.

| ID | DIMENSION | LEVEL1ID | LEVEL1NAME | LEVEL2ID | LEVEL2NAME |
|---|---|---|---|---|---|
| 3139 | 13 | 2697 | Previously | 2697 | External |
| | | | Viewed | | Referrals |
| | | | Resource | | |

The CATEGORY_NAMES dependency list is again empty, so this row is inserted into the target CATEGORY_NAMES table, and processing continues with the next dependency. The REFERRAL_ID value (8548856) needs to be a value of REFERRAL_NAMES.ID, but it is not. So the dependencies for REFERRAL_NAMES are inferred, of which there are two:

| | | | | |
|---|---|---|---|---|
| CATEGORY_NAMES | ID | REFERRAL_NAMES | CATEGORY_2_ID | 2 |
| REFERRALHOST_NAMES | ID | REFERRAL_NAMES | HOSTID | 2 |

Then the proper row is obtained from the source Referral_Names table:

| ID | NAME | HOST_ID | CATEGORY_13_ID |
|---|---|---|---|
| 8548856 | no_referral | 19800588 | 4059 |

The CATEGORY_ID is missing from CATEGORY_NAMES, so an empty (again) list of dependencies is collected for that table, the proper row from the source table is retrieved, the dependencies are checked by a recursive call that quickly returns, and the row is added to the CATEGORY_NAMES target table; the FACT.HOST_ID-to-REFERRALHOST_NAMES.ID dependency is treated similarly. The SEARCHENGINES and SEARCHENGINE_KEYWORD tables are still both empty, so their 0 entries are added to both. For SEARCHENGINE_KEYWORD this means adding a CATEGORY_NAME row because of its level 2 dependency.

Now, again back up to the Level 0 dependency list, the RESCGI_Q_NAMES dependency is processed in the same fashion as was the REFCGI_Q_NAMES dependency. Then the TIME_VALUES dependency is processed, which is like the first three in involving no further dependencies.

Now all six dependencies have been met, accomplished by inserting 18 rows into the dimension tables and their parents So now the first fact row can be inserted.

For the second Fact row (here are the first two rows again:),

| | | | RES_CGI_{—} | REF_CGI_{—} | | |
|---|---|---|---|---|---|---|
| DATE_ID | TIME_ID | PROTOCOL | PARMS | PARMS | COOKIE | BYTES |
| 92 | 39334 | 1 | 9738882 | 1974101 | 2478241 | 0 |
| 92 | 69198 | 1 | 4426097 | 11385 | 0 | 0 |

processing is carried out much as it was for the first row, except that the values for PROTOCOL and DATE_ID have already been inserted into their target database tables. So when ensureDependcies( ) probes for those values it will find them. When it does it will return without going through the trouble of forming a dependency list, retrieving the source database table's row and ensuring those dependencies. It will just return.

For row three,

| | | | RES_CGI_ | REF_CGI_ | | |
|---|---|---|---|---|---|---|
| DATE_ID | TIME_ID | PROTOCOL | PARMS | PARMS | COOKIE | BYTES |
| 92 | 39334 | 1 | 9738882 | 1974101 | 2478241 | 0 |
| 92 | 69198 | 1 | 4426097 | 11385 | 0 | 0 |
| 92 | 45990 | 2 | 1880139 | 55324 | 1004438 | 0 |

the DATE_ID will be found, and PROTOCOL will be new, so its dependencies (if any, and there are none in this example) will have to be ensured. Then for the next two rows,

| | | | RES_CGI_ | REF_CGI_ | | |
|---|---|---|---|---|---|---|
| DATE_ID | TIME_ID | PROTOCOL | PARMS | PARMS | COOKIE | BYTES |
| — | — | — | — | — | — | — |
| 92 | 41486 | 1 | 10091509 | 59246 | 0 | 5 |
| 92 | 64434 | 1 | 10091054 | 59438 | 0 | 5 |

PROTOCOL, DATE_ID, AND COOKIE will be found from previous insertions.

Set forth below is a list showing the sequence of insertions into the target database tables that culminates in the insertion of the first fact table row. Values that required pre-existing values are underlined, and all are found as the first (key) value in a prior insertion.
Insert into cookie_names values=(2478241, ‘iv_id=bookschlep’);
Insert into date_values values=(92, 2002, ‘Dec. 1, 2002’, ‘Dec. 1, 2002’, ‘Dec. 1, 2002’, 1)
Insert into protocol_names values=(1, ‘HTTP/1.1’);
Insert into category_names values=(3139,13,2697, ‘Previously Viewed Resource’, 2699, ‘External Referrals’);
Insert into category_names values=(4059, 2, 562, ‘Visitor Referral’, 562, ‘Visitor Referral’);
Insert into referralHost_names values=(19800588, ‘no referral’, 0);
Insert into referralNames values=(8548856, ‘no referral’, 19800588, 4059):
Insert into search_engines values=(0, none);
Insert into category_names values=(3133, 14, 2727, ‘Search Engine KeyWords’, 2730, ‘Non Search Engine Referral’);
Insert into searchEngine_keywords=(0, ‘Non Search Engine Referral’, 3133);
Insert into refcgi_q_names values=(1974101. ‘no referral’, 8548856, 0, 0, 3139)
Insert into category_names values=(4310, 1,2 ‘Content Category’, null, null)
Insert into category_names values=(3190,3,601, ‘Traffic Type’, 647, ‘Pages’);
Insert into category_names values=(1215, 8,1531, ‘Visitor Entry Resource’, 1895, ‘iV_Authentication’);
Insert into category_names values=(1216, 9,2090, ‘Visitor Exit Page’, 2455 ‘iV_Authentication);
insert into resource_names values=(2412459, ‘/ivillageauth/us/actv’);
Insert into rescgi_q_names values=(9738882, ‘/ivillageauth/us/actv’, 2412459, 4310, 3190, 1215, 1216);
insert into time_values values=(39334, 10, 55, 33, 1);
insert into fact values=(92, 39334, 1, 97388892, 1974101, 2478241, 0);

It will be understood from the foregoing description that Typical methods of populating databases according to embodiments of the present invention implement solutions capable of both picking out just the rows needed from dimension tables (and their own parents) and inserting them in the proper order so that referential integrity is preserved regardless whether integrity checking is on or off in the target database. It will be understood also from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for populating a database, the method comprising:
providing a database having a schema;
inferring from the schema dependencies among a fact table and related dimension tables; and
inserting, in accordance with the dependencies, rows of data into the fact table and rows of data into the dimension tables.

2. The method of claim 1 wherein inferring dependencies further comprises:
selecting from metadata describing a schema for the database expressions of dependencies; and
inserting the expressions of dependencies into a dependency list.

3. The method of claim 1 wherein inserting rows of data further comprises:
determining whether related dimension data exists for each foreign key in each row of data inserted into the fact table; and
for each foreign key for which related dimension data does not exist, inserting a row of dimension data into a dimension table related to the fact table through the foreign key.

4. The method of claim 1 wherein inserting rows of data further comprises:
determining whether related dimension data exists for each foreign key in each row of data inserted into a first dimension table; and
for each foreign key for which related dimension data does not exist, inserting a row of dimension data into a second dimension table related to the first dimension table through the foreign key.

5. The method of claim 1 wherein inserting rows of data further comprises:
reading the rows of data from a first database, the first database comprising dependencies among tables in the database; and
inserting rows of data into a second database, the second database comprising at least the same dependencies as in the first database.

6. The method of claim 1 wherein a dependency comprises a rule for the database, enforced by a database management system, that a first record in a first table must exist in the database before a second record in a second table may be inserted in the database.

7. A system for populating a database, the system comprising:
means for providing a database having a schema;
means for inferring from the schema dependencies among a fact table and related dimension tables; and
means for inserting, in accordance with the dependencies, rows of data into the fact table and rows of data into the dimension tables.

8. The system of claim 7 wherein means for inferring dependencies further comprises:
means for selecting from metadata describing a schema for the database expressions of dependencies; and
means for inserting the expressions of dependencies into a dependency list.

9. The system of claim 7 wherein means for inserting rows of data further comprises:
means for determining whether related dimension data exists for each foreign key in each row of data inserted into the fact table; and
for each foreign key for which related dimension data does not exist, means for inserting a row of dimension data into a dimension table related to the fact table through the foreign key.

10. The system of claim 7 wherein means for inserting rows of data further comprises:
means for determining whether related dimension data exists for each foreign key in each row of data inserted into a first dimension table; and
for each foreign key for which related dimension data does not exist, means for inserting a row of dimension data into a second dimension table related to the first dimension table through the foreign key.

11. The system of claim 7 wherein means for inserting rows of data further comprises:
means for reading the rows of data from a first database, the first database comprising dependencies among tables in the database; and
means for inserting rows of data into a second database, the second database comprising at least the same dependencies as in the first database.

12. The system of claim 7 wherein a dependency comprises a rule for the database, enforced by a database management system, that a first record in a first table must exist in the database before a second record in a second table may be inserted in the database.

13. A computer program product for populating a database, the computer program product comprising:
a recording medium;
means, recorded on the recording medium, for providing a database having a schema;
means, recorded on the recording medium, for inferring from the schema dependencies among a fact table and related dimension tables; and
means, recorded on the recording medium, for inserting, in accordance with the dependencies, rows of data into the fact table and rows of data into the dimension tables.

14. The computer program product of claim 13 wherein means for inferring dependencies further comprises:
means, recorded on the recording medium, for selecting from metadata describing a schema for the database expressions of dependencies; and
means, recorded on the recording medium, for inserting the expressions of dependencies into a dependency list.

15. The computer program product of claim 13 wherein means for inserting rows of data further comprises:
means, recorded on the recording medium, for determining whether related dimension data exists for each foreign key in each row of data inserted into the fact table; and
for each foreign key for which related dimension data does not exist, means, recorded on the recording medium, for inserting a row of dimension data into a dimension table related to the fact table through the foreign key.

16. The computer program product of claim 13 wherein means for inserting rows of data further comprises:
means, recorded on the recording medium, for determining whether related dimension data exists for each foreign key in each row of data inserted into a first dimension table; and
for each foreign key for which related dimension data does not exist, means, recorded on the recording medium, for inserting a row of dimension data into a second dimension table related to the first dimension table through the foreign key.

17. The computer program product of claim 13 wherein means for inserting rows of data further comprises:
means, recorded on the recording medium, for reading the rows of data from a first database, the first database comprising dependencies among tables in the database; and
means, recorded on the recording medium, for inserting rows of data into a second database, the second database comprising at least the same dependencies as in the first database.

18. The computer program product of claim 13 wherein a dependency comprises a rule for the database, enforced by a database management system, that a first record in a first table must exist in the database before a second record in a second table may be inserted in the database.
